(19) United States
(12) Patent Application Publication
(10) Pub. No.: US 2007/0056575 A1
(43) Pub. Date: Mar. 15, 2007

(54) Hand-Held Power Tool Device

(75) Inventors: Kai-Ulrich Machens, Stuttgart (DE); Jurgen Steinmaier, Notzingen (DE)

Correspondence Address: GUDRUN E. HUCKETT DRAUDT, LONSSTR. 53, WUPPERTAL, 42289, DE

(73) Assignee: Andreas Stihl AG & Co. KG, Waiblingen (DE)

(21) Appl. No.: 11/470,267

(22) Filed: Sep. 6, 2006

(30) Foreign Application Priority Data
Sep. 10, 2005 (DE) 10 2005 043 118.6

(51) Int. Cl. B28D 1/04

(52) U.S. Cl. 125/13.01; 173/162.1; 30/264

(57) ABSTRACT

A power tool device has a tool and a housing. An extension arm is provided that has a first end connected to the housing and a second end on which second end the tool is rotatably supported. A drive motor is arranged in the housing and rotatingly drives the tool. At least one mass body having a mass and being movably supported on a support is arranged in the area of the second end of the extension arm. The mass of the mass body or the support of the mass body or both are matched to vibrations occurring at the second end of the extension arm in operation of the power tool device so that the mass body at least partially compensates the vibrations occurring in operation of the power tool device.

### BACKGROUND OF THE INVENTION

The invention relates to a power tool device, particularly a hand-held power tool device, such as a cut-off machine or the like. A drive motor is arranged in the housing and rotatingly drives the tool. The power tool has an extension arm that is secured with a first end to the housing and whose second end carries the tool that is rotatably supported thereon.

U.S. 2004/0248506A1 discloses a cut-off machine with an extension arm. One end of the extension arm is secured to the housing of the cut-off machine and the other end of the extension arm rotatably supports the cutting wheel. In operation of the cut-off machine, vibrations occur on the cutting wheel and on the end of the extension arm supporting the cutting wheel and are transmitted through the extension arm to the housing. The vibrations are transmitted also onto the handles and must be compensated by the operator. This leads to stress being experienced by the operator and causes the operator to experience fast onset of fatigue when working with the cut-off machine. The vibrations also stress the material of the cut-off machine so that the cut-off machine must be constructed comparatively strongly in order to provide a sufficiently long service life.

### SUMMARY OF THE INVENTION

It is an object of the invention to provide a power tool device of the aforementioned kind that, while having a simple configuration, provides for a minimal stress load on the operator during operation.

This object is solved by a power tool device of the aforementioned kind having at least one mass body that, in the area of the second end of the extension arm, is movably supported, wherein the mass (weight) of the mass body and/or the support of the mass body is matched to the vibrations occurring at the second end of the extension arm so that the mass body at least partially compensates the vibrations occurring in operation of the power tool device.

The arrangement of at least one mass body in the area of the second end of the extension arm enables at least partially the compensation of the occurring vibrations at the location of origin of the vibrations so that the vibrations that are transmitted into the housing of the power tool device are reduced. Because fewer vibrations are transmitted into the housing, a massive configuration of the housing is not needed. The mass or weight of the mass body is small relative to the total weight of the power tool device so that no significant increase of the total weight of the power tool device results.

Expediently, the mass body is movably supported in at least one main vibration direction of the tool. In particular, the power tool device is a cut-off machine and the tool is a cutting wheel. In this context, the mass body is advantageously movably supported in a direction transverse to the plane of the cutting wheel. In operation, the cutting wheels cause a so-called “hat” vibration of the cutting wheel. This is a warping vibration of the wheel that usually appears in the range of the cut-off speed, i.e., the maximum speed that occurs in operation. The “hat” vibration however can also occur at a different speed within the working range of the power tool device. In order to reduce the transmission of said vibration into the housing, it is provided that the mass (weight) and/or the support of the mass body is matched to the “hat” vibration of the cutting wheel. In this way, the vibrations generated by the cutting wheel can be greatly reduced.

Expediently, the mass body is movably supported in at least one main vibration direction of the extension arm. The extension arm has usually a bending or torsional resonance that generally occurs at engine speeds below the working speed and therefore represents a passing resonance. The vibration of the extension arm is essentially a transverse vibration. Expediently, the mass and/or the support of the mass body is adjusted to the transverse vibration of the extension arm. In this way, the transmission of the transverse vibrations of the extension arm into the housing can be significantly reduced.

Expediently, the mass body is supported in the area of the axis of rotation of the tool. In particular, the mass body is a protective cover of the tool. Especially in the case of cut-off machines, a protective cover is provided on the tool anyway. For compensating the occurring vibrations, the mass and the support of the protective cover on the extension arm must only be matched to the occurring vibrations. For an at least partial vibration compensation, no additional components are therefore required. The weight of the power tool device is not increased because a part that is already present on the power tool device is used as a mass body.

It can be provided that a mass body is secured on the protective cover of the tool. The mass body is in particular arranged inside the protective cover.

Advantageously, the mass body is movably supported by means of at least one spring element. Expediently, several spring elements are provided for supporting the mass body. In particular, at least one spring element is a coil spring. It is provided that a mass body is moveably supported by at least one damping element, in particular a spring damping element. The damping element is comprised preferably at least partially of rubber. In particular, a rubber disk is provided as a damping element. The damping elements and spring elements can be combined for achieving an excellent vibration damping action. In order to dampen vibrations in several directions, spring elements and/or damping elements can be used for tying in the mass body in different directions, wherein in particular different resonant vibrations in different directions are compensated by different spring elements and/or damping elements.

### BRIEF DESCRIPTION OF THE DRAWINGS

Embodiments of the invention will be explained in the following with the aid of the drawing.

FIG. 1 shows a side view of the cut-off machine.

FIG. 2 is a schematic plan view of a first embodiment of the cut-off machine of the present invention.

FIG. 3 is a schematic plan view of a second embodiment of the cut-off machine of the present invention.

FIG. 4 is a schematic plan view of a third embodiment of the cut-off machine of the present invention.

FIG. 5 is a schematic plan view of a fourth embodiment of the cut-off machine of the present invention.

FIG. 6 is a schematic plan view of a fifth embodiment of the cut-off machine of the present invention.

### DESCRIPTION OF PREFERRED EMBODIMENTS

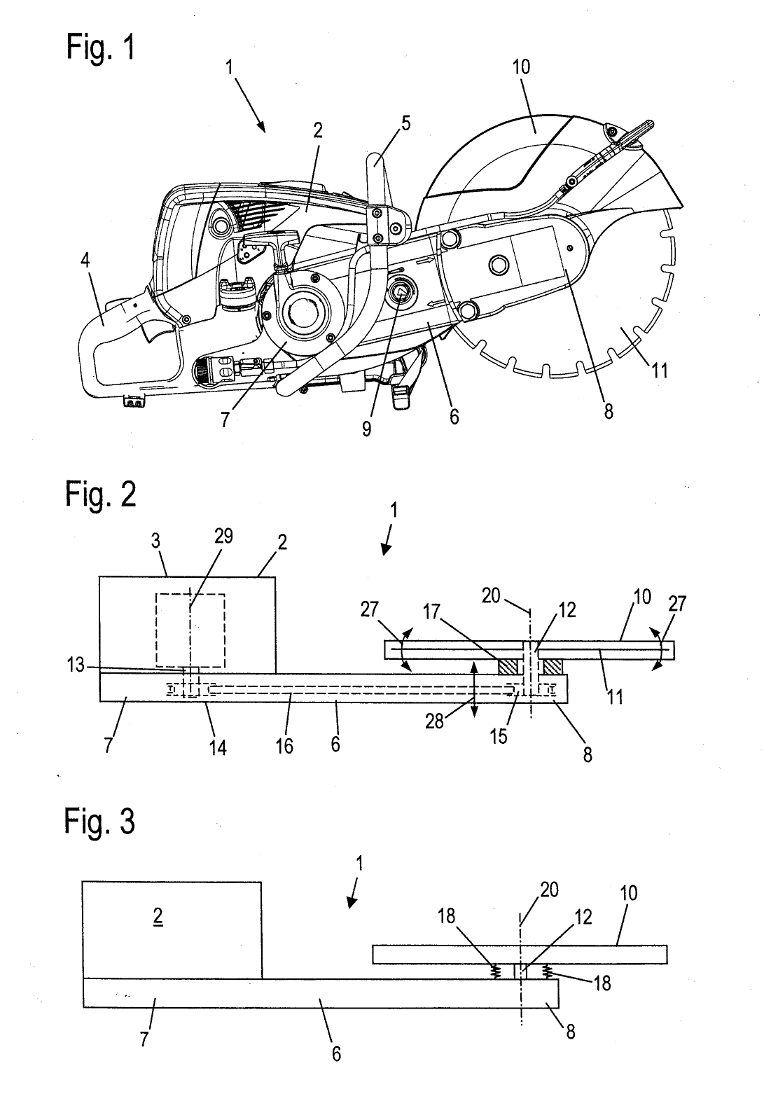

The cut-off machine 1 illustrated in FIG. 1 has a housing 2 on which a rear handle 4 and a handle pipe 5 for handling the cut-off machine 1 are secured. The cut-off machine 1 has a rotatingly driven cutting wheel 11 that is arranged on an end of the housing 2 that is opposite the rear handle 4. The handle pipe 5 surrounds the housing 2 in the vicinity of the cutting wheel 11. The cutting wheel 11 is secured by means of the extension arm 6 to the housing 2. The first end of the extension arm 6 is secured to the housing 2. On the second end 8 of the extension arm 6 remote from the housing 2, the cutting wheel 11 is rotatably supported on a drive shaft 12 that is illustrated in FIG. 2. The extension arm 6 can be a monolithic part. The section of the extension arm 6 comprising the first end 7 can however also be attached to the housing 2 while the section of the extension arm 6 comprising the second end 8 is movable relative to the section comprising the first end 7. For enabling a relative movement of the two sections of the extension arm 6 relative to one another or of the extension arm 6 relative to the housing 2, a V-belt tensioning device 9 is provided. The section of the extension arm 6 comprising the first end 7 can be formed as a monolithic component of a part of the housing 2. On the second end 8 of the extension arm 6 a protective cover 10 is arranged that extends about the cutting wheel 11.

As shown in the schematic illustration of FIG. 2, the cut-off machine 1 has a drive motor 3 arranged in the housing 2; the drive motor is in particular an internal combustion engine, preferably a two-stroke engine. The internal combustion engine 3 has a crankshaft 13 that drives in rotation a first pulley 14. The first pulley 14 is arranged in the area of the first end 7 of the extension arm 6 and drives a V-belt 16. In the area of the second end 8 of the extension arm 6 a second pulley 15 is arranged that is rotatingly driven by the V-belt 16 and is fixedly connected to the drive shaft 12 of the cutting wheel 11. The drive shaft 12 is thus rotatingly driven about its axis of rotation 20 by the drive motor 3. The drive shaft 12 is approximately perpendicular to the longitudinal extension of the extension arm 6 and approximately parallel to the axis of rotation 29 of the crankshaft 13 of the drive motor 3. The extension arm 6 is essentially elongate and flat. The main extension of the extension arm 6 is in a plane that is parallel to the plane of the cutting wheel 11.

In the embodiment illustrated in FIG. 2, the protective cover 10 forms a mass body that is movably supported by spring damping element 17 in a direction transverse to the plane of the cutting wheel 11 and of the extension arm 6. The spring damping element 17 is preferably a rubber disk that is penetrated by the drive shaft 12. The spring damping element 17 is comprised expediently of an elastomer with an inner damping action and has spring properties as well as damping properties. On the drive shaft 12, the cutting wheel 11 is fixedly supported. When running up the internal combustion engine 3, the extension arm 6 vibrates in the area of its second end 8 with a transverse vibration 28. The transverse vibration 28 is generated in general at an engine speed below the working range. In particular in the area of the engine cut-off speed the cutting wheel 11 vibrates with a “hat” vibration 27 in a direction transverse to the plane of the cutting wheel 11. The support of the protective cover 10 and the mass of the protective cover 10 are matched to the transverse vibration 28 and/or the “hat” vibration 27 so that the protective cover 10, at an engine speed at which the transverse vibration 28 is generated, vibrates counter to the transverse vibration 28 and compensates it at least partially and/or the protective cover 10, at the engine speed at which the “hat” vibration 27 is generated, vibrates counter to the “hat” vibration 27 so that the “hat” vibration 27 is at least partially compensated. The protective cover 10 can be matched to the transverse vibration 28 as well as to the “hat” vibration 27 when the protective cover 10 has two resonant frequencies. However, it is also possible to provide an additional mass body so that the protective cover at least partially compensates the transverse vibration 28 or the “hat” vibration 27 and the additional mass body is matched to and at least partially compensates the other one of the two vibrations.

In the illustrated embodiment of FIG. 3, spring elements 18 are provided in place of the spring damping element 17 on which spring elements 18 the protective cover 10 is supported. The protective cover 10 is springily supported in a main vibration direction of the extension arm 6 and/or of the cutting wheel 11. The spring elements 18 are coil springs. However, other spring elements can also be expedient. In FIG. 3, two spring elements 18 are illustrated; however, a different number of spring elements, for example, one spring element or four spring elements, can be provided also.

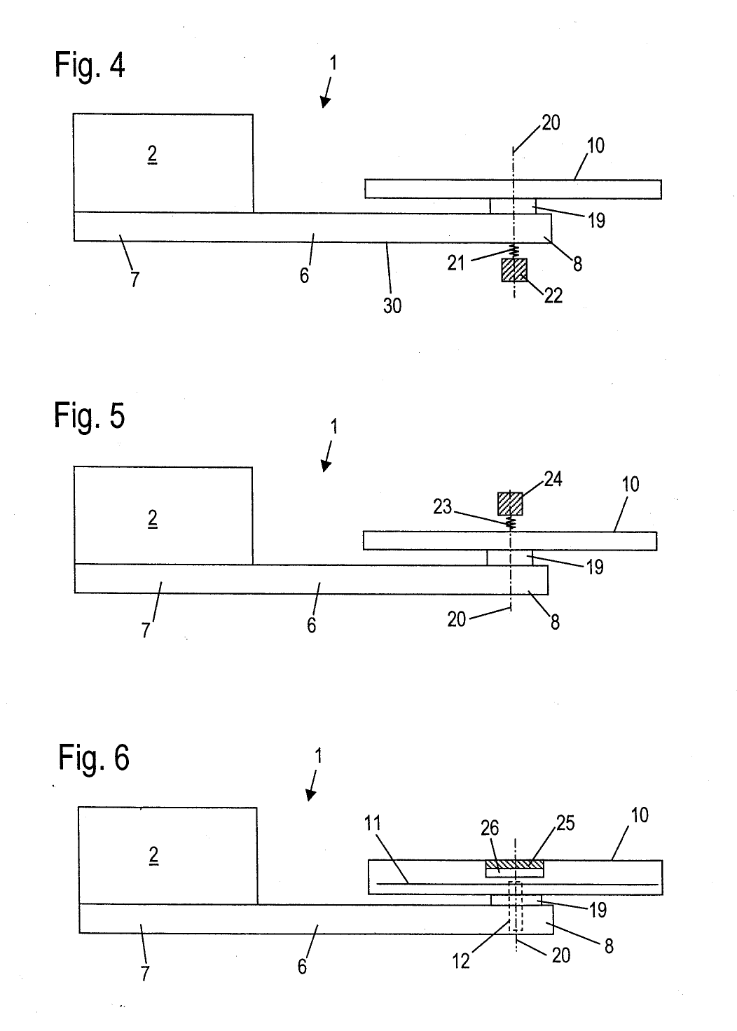

The embodiment of the cutting wheel 1 illustrated in FIG. 4 shows that the protective cover 10 is secured by a flange 19 on the second end 8 of the extension arm 6. The drive shaft 12 (not illustrated in FIG. 4) of the cutting wheel 11 passes through the flange 19. On the elongate side 30 of the extension arm 6 opposite the protective cover 10, a mass body 22 is supported at the level of the axis of rotation 20 of the drive shaft 12 by means of a spring element 21. The spring element 21 is preferably configured as a coil spring. Instead of the coil spring 21 it is also possible to provide to spring damping element. The mass body 22 is movably supported in the main vibration direction of the extension arm 6 and/or of the cutting wheel 11. Preferably, the mass body 22 is movable transversely to the plane of the extension arm 6 and the cutting wheel 11. The support and/or the mass of the mass body 22 is preferably matched to the resonant frequency of the extension arm 6. For at least partial compensation of the resonant frequencies of the cutting wheel 11, an additional mass body, not shown in FIG. 4, can be provided.

The embodiment of a cut-off machine 1 illustrated in FIG. 5 shows on the side of the protective cover 10 that is facing away from extension arm 6 a mass body 24 that is movably supported by spring element 23. The mass body 24 is preferably movable in the main vibration direction of the cutting wheel 11 and/or of the extension arm 6, in particular transversely to the plane of the cutting wheel 1 and the extension arm 6. The weight and/or the support of the mass body 24 are configured in this connection such that the vibrations occurring in operation of the cutter 1 are at least partially compensated.

In the embodiment of the cutter 1 illustrated in FIG. 6, a mass body 26 is supported movably by means of a spring damping element 25, preferably by a damping disk, on the protective cover 10. The spring damping element 25 is comprised in particular of an elastic material with inner damping action that has spring properties and damping properties. It is also possible to use, in place of the spring damping element 25, an element providing a pure damping action. Preferably, a separate spring element is provided in addition to the damping element. In this connection, the mass body 26 is arranged inside the protective cover 10. The mass body 26 can however be arranged also on the exterior side of the protective cover 10. The protective cover 10 is connected by a flange 19 on the second end of the extension arm 6. The mass body 26 is arranged in the area of the axis of rotation 20 of the drive shaft 12 and is movably supported in the direction of the main vibration direction of the cutting wheel 11 and/or of the extension arm 6. In particular, the mass body 26 is moveable in the longitudinal direction of the axis of rotation 20. The mass body 26 however can also be arranged in the area of the circumference of the protective cover 10. It is also possible to provide several mass bodies 26 that are distributed about the circumference of the protective cover 10. In addition, on the second end 8 of the extension arm 6 a mass body can be arranged. The mass bodies illustrated in FIGS. 2 through 6 and their support can be combined with one another in order to achieve a compensation as good as possible of the vibrations occurring during operation. Preferably, a mass body is arranged in the area of the second end of the extension arm 6. In this connection, the second end 8 of the extension arm 6 refers to approximately that third of the extension arm that is facing away from the housing. An arrangement of the mass body in the area of the axis of rotation is advantageous. The vibration compensation according to the invention can also be advantageous for other power tool devices.

The instant application incorporates by reference the entire disclosure of German priority document 10 2005 043 118.6 having a filing date of 10 Sep. 2005.

While specific embodiments of the invention have been shown and described in detail to illustrate the inventive principles, it will be understood that the invention may be embodied otherwise without departing from such principles.

What is claimed is:

1. A power tool device comprising:
a tool;
a housing;
an extension arm having a first end connected to the housing and a second end on which second end the tool is rotatably supported;
a drive motor arranged in the housing and rotatingly driving the tool;
at least one mass body having a mass and being movably supported on a support in the area of the second end of the extension arm;
wherein at least one of said mass and said support of the at least one mass body is matched to vibrations occurring at the second end of the extension arm in operation of the power tool device so that the at least one mass body at least partially compensates the vibrations occurring in operation of the power tool device.

2. The power tool device according to claim 1, wherein the at least one mass body is movably supported in at least one main vibration direction of the tool.

3. The power tool device according to claim 1, wherein the power tool device is a cut-off machine and the tool is a cutting wheel.

4. The power tool device according to claim 3, wherein the at least one mass body is movably supported transversely to a plane of the cutting wheel.

5. The power tool device according to claim 3, wherein said at least one of said mass and said support of the at least one mass body is matched to a hat vibration of the cutting wheel.

6. The power tool device according to claim 1, wherein the at least one mass body is movably supported in at least one main vibration direction of the extension arm.

7. The power tool device according to claim 6, wherein at least one of said mass and said support of the at least one mass body is matched to a transverse vibration of the extension arm.

8. The power tool device according to claim 1, wherein the at least one mass body is supported in the area of an axis of rotation of the tool.

9. The power tool device according to claim 1, further comprising a protective cover covering the tool, wherein the protective cover is the at least one mass body.

10. The power tool device according to claim 1, further comprising a protective cover covering the tool, wherein the at least one mass body is secured on the protective cover of the tool.

11. The power tool device according to claim 1, further comprising a protective cover covering the tool, wherein the at least one mass body is arranged inside the protective cover.

12. The power tool device according to claim 1, wherein said support is at least one spring element movably supporting the at least one mass body.

13. The power tool device according to claim 12, wherein several of said at least one spring element are provided for supporting the at least one mass body.

14. The power tool device according to claim 12, wherein the at least one spring element is a coil spring.

15. The power tool device according to claim 1, wherein said support is at least one damping element movably supporting the at least one mass body.

16. The power tool device according to claim 15, wherein the at least one damping element is a spring damping element.

17. The power tool device according to claim 15, wherein the at least one damping element is comprised at least partially of rubber.
